(19) United States
(12) Patent Application Publication
(10) Pub. No.: US 2025/0322419 A1
(43) Pub. Date: Oct. 16, 2025

(54) Systems and Methods for Fan Evaluation and Community Development

(71) Applicant: Florido Limited, St. Albans (GB)

(72) Inventors: Philip Mordecai, St. Albans (GB); Gary B. Fogel, San Diego, CA (US)

(21) Appl. No.: 18/972,495

(22) Filed: Dec. 6, 2024

Related U.S. Application Data
(60) Provisional application No. 63/632,345, filed on Apr. 10, 2024.
(60) Provisional application No. 63/679,496, filed on Aug. 5, 2024.

(51) Int. Cl. G06Q 30/0204; G06Q 30/0242

(52) U.S. Cl. CPC G06Q 30/0204; G06Q 30/0242

(57) ABSTRACT

Novel systems and methods to determine a person's status as a fan of a product and/or service through machine learning for the purpose of customer management, community management, product development, directed marketing, and branded content entertainment in a dynamic, real-time, and optimized manner. These novel systems and methods also for optimizing the delivery of marketing and non-marketing content to fans making use of an ecosystem, such as an embargo hub, for the analysis and understanding of fan behavior in terms of fan-content interaction, fan-community interaction, and their combination.

### RELATED APPLICATIONS

This application claims the benefit of priority from U.S. Provisional Application No. 63/632,345 filed Apr. 10, 2024, and U.S. Provisional Application No. 63/679,496 filed Aug. 5, 2024, the contents of which are hereby incorporated by reference herein.

### FIELD OF THE INVENTION

The present invention provides novel systems and methods to determine a person's status as a fan of a product and/or service through machine learning for the purpose of customer management, community management, product development, directed marketing, and branded content entertainment in a dynamic, real-time, and optimized manner. These novel systems and methods also allow for the determination of the monetary value of marketing content and fan communities for advertising relative to the behaviors of individual fans or fan communities. While the history of marketing offers many techniques to help target content to specific users, these approaches generally lack an understanding of what it means to be a “fan” of the brand, product, service, or any combination thereof that is being marketed. Further, such approaches have difficulty identifying and targeting fans and then enlisting their assistance in evaluating novel content through a secured system prior to larger content release to a broader audience. The present invention makes use of such a marketing ecosystem including a secure platform known as an “embargo hub” combined with known fan communities to showcase marketing content, evaluate and adjust said content dynamically, simultaneously developing a better model of what it means to be a “fan” in various contexts, how then to identify new likely fans and their associated communities, and how to generate new content that will be of greatest interest to those fans and associated communities or their combination. By understanding fans, their associated communities, and adjacent fandoms via the ecosystem, the systems and methods described here improve the delivery of content to fans in a precise way, improve the understanding of the behaviors and dynamics of individual fans to fan communities, improve the understanding and relatedness of fan communities, improve the understanding of content's media value, thereby enhancing overall marketing effectiveness and measured outcomes such as return on investment, sales, and revenue.

### BACKGROUND OF THE INVENTION

A portion of our systems and methods focus on an improved understanding of what it means to be a “fan,” qualification for being a fan, characteristics of fan “communities,” and how to measure fan communities and “fandom” quantitatively, qualitatively, or both quantitatively and qualitatively through the delivery of content in a specific manner to assess resulting behavioral changes across individual fans and within fan communities. For instance, quantitative measures such as the number and type of interactions with specific content can be used as well as qualitative measures such as personal opinion. This includes examining relationships of fans to marketing content, similarities or commonalities between fans, following the deployment of content and subsequent fan interactions within a specifically designed ecosystem for the improved understanding of such relationships and interactions. The formation of a fan community is not determined solely by a specific number of fans but rather by the quality and quantity of interaction, engagement among them in their fan communities, and adjacent fan communities, and their collective and individual behaviors.

Key attributes in measuring fandom include the connections and behaviors of fans. Fandom is a community of fans who share a common interest, and it serves as a social space where fans interact and celebrate their passions. Fandom is defined by community engagement, including gatherings and discussions, and it often develops its own unique culture and shared values. A fan community encompasses more than just shared interests from two or more fans; it involves social connections, interactions, participation, shared interests, cultural values, common goals, competition, social status, a general sense of loyalty, a fear of missing out on latest trends, forms of symbiosis, an emotional sense of belonging, or some or all of the above. Such fan communities are essential for product advocacy emanating from a trust network. Consequently, sub-groups of fans may emerge within the larger fan community as they interact and connect over common interests. Such fan sub-groups or fan communities can also serve as a source of information for improved marketing decisions no matter if the fan reaction is positive, neutral, or negative. Conversely, as an example, individuals who appreciate a product or brand or product and brand, but do not engage with others around the product and/or brand, would not be considered part of the product fan community. In the case of a monopoly, consumers have little choice in the matter of the product they buy and while considered as “loyal” customers, they may not truly be part of a product fan community. In the case of a product that is chemically addictive, addicted consumers may have less inherent choice about their status as a fan as they may purchase a product simply to satisfy the addition. The ecosystem described by our systems and methods allows for the determination of actual fan status despite these concerns and does not rely solely on purchase attribution or social media attributions or the combination of purchase attribution and social media attribution. Additionally, it is not always the case that fans become a community out of interest for example a product and/or a brand, an interest or an organization such as a team or group, but rather they can be a fan of a community that is counter-culture, toxic or anti-establishment, and in this case their “fandom” is in shared opposition to a product. As such fandom can be said to exist on a spectrum from −1 (definitely not a fan) to 0 (ambivalence) to +1 (definitely a fan) where for any fan this value can change with time. In our approach, these varying measurements are factored into fandom metrics and are used to assist in the optimization of content delivery to consumers of that content in a tiered or continuous, relative to their level of fandom, fanness, and community involvement, approach that uses known fans to help evaluate content before its wider distribution to a broader audience, to help adjust the content, fan-value the content together with any potential advertising around the fan-content and to aid identification of new or likely fans of that content from a broader pool of potential fans. Such systems and methods could be used to improve overall fan community, customer retention, loyalty, calculate the environmental impact of marketing to a fan and fan community or both fans and fan communities within each marketing channel, and brand engagement beyond traditional customer sales.

Previous approaches focus largely on transactional information for such measures. For instance, U.S. Pat. No. 9,165,270 discloses methods to predict the likelihood of customer retention or attrition. While useful, this approach makes use of transactional data and store location rather than the presentation of marketing material to such customers to determine their likelihood of liking or disliking the content. Many possible systems and methods can be devised to distribute and provide access to content to fans through marketing platforms. For instance, US Patent Pub. No. 2006/0085255, highlights the importance of brand equity as a crucial measure of marketing effectiveness. It uses historical data to develop brand equity metrics to aid in continuous improvement within organizations through the access to custom analytics dashboard. The invention differs from our approach significantly because it fails to provide capabilities or metrics for real-time data or fan feedback or the combination of real-time data and fan feedback of content within a marketing ecosystem that includes an embargo hub. Our systems and methods provide content to known fans through a marketing ecosystem. One such ecosystem, including a secured digital “embargo hub,” can be used to develop and launch products, engage with fan communities to showcase and build lasting brand discoverability and relationships, including custom fan-first content experiences in one secured destination using the blockchain, where real-time data can be collected about fan behaviors relative to content, using artificial intelligence or machine learning or statistical assessment or their combination to help understand fans, their behavior, metrics of fandom, brand growth in fan communities, and to provide content to fans in useful ways. Analog modules of the embargo hub include in-person focus groups, physical events, physical secured content and delivery, and their combination, and these can be also held on their own or in combination with a digital embargo hub. Within this embargo hub, fans are able to interact with content in discrete or continuous ways with their interactions recorded in real-time. These interactions then aid the generation of new content generation and help in the evaluation of fan behavior such that new fans can be identified. The embargo hub can also provide real-time feedback to assist in product development and focus group testing to help with valuable raw data in new product development areas.

The general concept of providing content to consumers is itself the very basis of marketing. As a result, there are many patents associated with the providing of content to individuals through various devices and approaches, however none make use of an embargo hub and a secure, decentralized distributed ledger system, such as a blockchain, in the novel manner that we describe. The blockchain facilitates the safe storage and sharing of content across a network of users, while also functioning as a decentralized ledger system for data collection, storage, and access. For instance, U.S. Pat. No. 10,345,897 disclosed methods for spectators to provide inputs to games through an application programming interface such that spectators may influence the game or become themselves involved with the game, typically through streaming services. While this approach mimics a type of embargo hub and allows for the collection of data about the spectators and their interaction with the game, it fails to utilize such data for improved marketing purposes or to determine fandom metrics beyond game environments. Similarly, U.S. Pat. No. 10,390,0064 offers a spectating system to allow participants to interact with a game, receive rewards, and offer comments on content, the focus of the system and method is on the value exchange of watching the content and not on how to gather information about such interaction for the adjustment of marketing content and timing or to specifically evaluate participants for their level of fandom.

U.S. Pat. No. 9,680,915 focuses on the identification of “influencers” through clustering networks. While the method offers flexibility in tuning data clusters and analyzing network topologies, its core methodology is predominantly focused on traditional network clustering metrics, such as centrality and link distance, to determine influential nodes as influencers. This system is insufficient for capturing the complexity of fandom, such as psychological and behavioral dimensions, and unlike our systems and methods which are focused on identifying fans and measuring levels of fandom, we account for emotional intensity, frequency of interaction, and the specific cultural markers that define fan behavior. U.S. Pat. No. 11,052,321 also focuses on the gathering of information about participants in game environments but is specific to instream participation metrics and rewards without any connection to social media data or fandom. U.S. Pat. No. 11,488,189 focuses on the identification of location data on a mobile device associated with sales promotions in a virtual game environment. While useful for scoring user interest and providing rewards, our system and method does not rely on mobile device location, or rewards in virtual games and focuses instead on the behavior of individuals as fans in an ecosystem such as an embargo hub to extract information about fandom, marketing content, and fan engagement irrespective of where they are located physically at the time of their interaction with said content.

U.S. Pat. No. 10,345,897 focuses on optimizing the effectiveness of communicating marketing content within platforms or digital media while simultaneously conducting cause-and-effect experiments and using machine learning. The purpose of the invention is to assess how content is optimized through experiments and machine learning algorithms to enhance effectiveness metrics. While in part this approach mimics the marketing optimization outcome method described in our systems and methods, it fundamentally precludes privacy-focused data optimization and/or the use of decentralized networks. The systems and methods of our invention specifically permit the use blockchain-based platforms such as an embargo hub and therefore allow for the targeting the collection and feedback of data without the need of centralized user data. Additionally, our systems and methods include data and information obtained both within an ecosystem similar to an embargo hub and outside of such an ecosystem, and our approach includes methods to permit the exchange of information from the fan ecosystem to and from third parties via a data gateway and application programming interface (API).

U.S. Pat. No. 11,392,969 centers on a system for profiling and predicting customer behavior using various data sources and advanced machine learning techniques. Its goal is to enhance sales, marketing, and customer analytics. This invention is a smart computer system designed to utilize historical data to help businesses anticipate their customer's future actions, enabling more effective targeting by accurately understanding their preferences and behaviors. Unlike our decentralized compatible ecosystem approach, this method does not consider fans or real-time data processing or analysis of marketing feedback. While approaches such as this make use of uni-directional data gateways to connect with third parties, through our systems and methods this data gateway can be either uni-directional or bi-directional and include data solutions provided by the product or brand being marketed.

Key attributes in the calculation of “fandom” are the level of “fanness.” Fanness refers to the experience of being a fan, marked by enthusiasm and dedication to a specific subject. It involves feelings and knowledge about the subject, reflecting a level of interest and emotional investment commitment, and also a level passion connection, the degree of knowledge, and possible visible indications of community membership. The embargo hub ecosystem can be used to determine where a fan exists on a spectrum of “fandom” and a level of “fanness” from being fully committed to a brand and/or fan community to being fully committed in opposition to a brand and/or fan community. An “uncommitted fan” has no community commitment whatsoever and sits at the middle of these two extremes. The dynamics of fan behavior can also be described. For instance, there “fringe fans” or “casual fans” or “fairweather fans” who change their commitment to a brand or community regularly as opposed to “super fans” or “pro fans” who retain loyalty to a brand or community no matter the circumstances. A fan community consists of two or more fans who share common interests, values, or goals, often engaging in regular interactions. Conversely, a fandom is a specialized type of community centered around a specific interest, characterized by heightened enthusiasm, communication, engagement and often active advocacy which can result in the creation and sharing of related content. Within the embargo hub, each fan's level of fandom is dynamic relative to a given brand and external forces. The embargo hub offers a unique opportunity to study fandom, its dynamics, to evaluate content in real-time relative to fan behavior, and to build brand fandom through the distribution of content within or external to the embargo hub deemed valued by brand fans from within the embargo hub.

U.S. Pat. No. 8,620,718 outlines a computer-implemented brand benchmarking system that utilizes social media metrics, such as fan page counts, to compare brands within the same industry and geographical area. The system evaluates brands based on specific metrics derived from social media interactions to develop audience and engagement scores for brand benchmarking. However, unlike our systems and methods, it is not specifically designed to optimize marketing content in real-time. While brand fan benchmarking is one potential outcome of our invention, U.S. Pat. No. 8,620,718 B2 focuses on the quantification and monitoring of social media network data to compute benchmark analyses and scores. In comparison, the ecosystem defined by our systems and methods offer a broader scope by incorporating real-time data feedback, plus offline and analogue data sources. Within the embargo hub fans can also be clustered into similar groups to determine demographic or other qualities that help drive fan behavior.

U.S. Pat. No. 10,362,072 provides an example of systems and methods for team conferencing using a real-time conference engine and virtual rooms to allow people to collaboratively experience libraries of rich media content in personalized rooms, fan pages, or websites. While this is a useful example of how content can be distributed to groups of individuals to help understand their behavior, there is no direct connection to a system with restricted access to that content based on fan qualification, nor is there a system that adjusts the identification of new fans and generation of new content in dynamic fashion relative to the behavior of fans within an embargo hub-like setting such as is offered in our systems and methods. U.S. Pat. No. 9,820,002 shares these same issues in that it provides a system and methods for the review of digital multimedia but has no mention of fans, fandom, or the recommendation of specific content based on the data being collected by this multimedia presentation. U.S. Pat. No. 10,339,541 focuses on the delivery of application media content to multiple social media systems for display to members of said social media systems. While the approach delivers content to specific groups of users, the system and method makes no reference to fandom or fans, or the measure of the quality of fans, or the adjustment of the media content based on the quality of those fans. U.S. Pat. No. 8,954,449 discloses a method for identifying a brand influencer by scanning social media objects published by at least one social networking entity to identify the first social media object posted by a first user and relating that to a brand associated with a product, an enterprise, a service, a person, a concept, and/or a trackable object. While influencers on occasion could be considered as a type of fan, the approach requires a multi-tenanted customer relationship management database for the analysis and scoring of brand influence of users only on a social media network. The approach does not make use of a private, secured, blockchain embargo hub ecosystem, nor does it seek to identify and score fans in general, simply influencers within social media networks. And while U.S. Pat. No. 8,954,449 makes use of a calculated “brand influence score,” their approach makes use of fans specifically to identify key influencers in social media, is focused on social media data collection and analysis, and comparison of the brand influence score to a predefined threshold. Our systems and methods are not predicated on the use of a predefined threshold, nor are they focused on finding key influencers in social media, rather we use an embargo hub to offer content to a fan community, measure qualitative and quantitative response from all fans in that community and consider them all as possible influencers, with valued insight about marketing content.

Our systems and methods for fandom metrics and content engagement are non-invasive and do not require specific devices to be applied to individuals for their measurement relative to marketing content. U.S. Pat. No. 8,688,541 focuses on online auction systems and utilizes the bidding history of users in the auctions to determine which users will be promoted to additional online auctions based on their bidding history. The invention is specific to bid and auction outcomes and adds users to a list for future marketing based on their bidding history rather than real-time marketing based on real-time actions to marketing content in an embargo hub where the content does not have to be specific to online auctions. U.S. Pat. No. 8,473,044 describes a system and method for the measure and ranking of response to an audiovisual or interactive media through the use of alpha asymmetry of the individual's brain via a specialized headset to capture brain signals. Our approach avoids the need for such headsets or other worn devices. While the embargo hub could include web-based content, our systems and methods do not require the tracking of individuals to specific websites on the internet. For instance, U.S. Pat. No. 8,417,557 evaluates the engagement of webpage visitors on a web server and uses this to associate a profile with each visitor. While this is a useful example of associating metrics or scores in a dynamic way relative to user behavior, their invention is specific to website data tracking and the tracking of visitors to websites over time. Our systems and methods provide marketing information and data to a group of predetermined cohort of fans who are each assigned unique user profiles through a secure embargo hub. This cohort represents all aspects of the fanness spectrum including those who are ambivalent about a product or service so as to act as a control group for marketing evaluation. The embargo hub is flexible to the many ways that fan users can interact with marketing content. Quantitative and qualitative measures are then associated with a fan user profile and are not solely reliant on how often a user visits a website over time to score their degree of fandom.

Thus, there is still a clear need to optimize the presentation of content to the community of fan users in the hopes of identifying new fans. Our novel systems and methods test and optimize content by publishing and engaging with a cohort the fan community, adjusting the content in real-time to their interests and behaviors. The content in the embargo hub can be in the form of video-on-demand, live-streaming video, images, photographs, audio, text, posts, messages, community forums, electronic quizzes, advertisements, websites, icons, interactive experiences, or any combination of these, or all of these, either via digital or analog such as via online websites or physical devices or any combination thereof, regardless of the brand industry, and where said content and/or presentation are relative to the actual data collected from the interaction of users in an ecosystem such as an embargo hub.

### SUMMARY OF THE INVENTION

This invention provides systems and methods for optimizing the delivery of marketing and non-marketing content to fans making use of an ecosystem, such as an embargo hub, for the analysis and understanding of fan behavior in terms of fan-content interaction, fan-community interaction, and their combination. The invention allows known fans to interact with content in a secured ecosystem, such as an embargo hub, via modern secure internet experiences and blockchain technology solutions and for data collection. The systems and methods make use of two cycles of learning, the first cycle draws lessons learned from the ecosystem about fandom metrics towards the discovery of new fans from the set of all possible fans to help increase market share while the second cycle draws lessons learned from the ecosystem to help improve the content that is being provided back to the fans in real-time. The systems and methods result in data, data analysis, and machine learning approaches that also help understand fandom in new ways and improve the overall quality of the fan experience and community connections, trusted fan relationships, fan sentiment, brand-fan loyalty, or any combination, or all of these in light of optimized content. The ecosystem data can then be merged with third party data, with intent to transfer to third parties with trust through a secure data gateway.

In one aspect, the present invention provides systems and methods to provide content in an optimized manner to a cohort of fans, comprising: a marketing ecosystem including an embargo hub for the collection and storage of data about fan dynamics and content interaction, wherein knowledge of that interaction can be used to drive decisions regarding content adjustment, and the ability to identify new fans that are likely to respond well to that content. These same systems and methods can collect data about fans who convert into non-fans through their lack of interaction or negative interaction with embargo hub content, and thereby also avoid or reduce marketing inefficiency.

Today, dynamic digital marketing typically mixes and matches demand (advertisers seeking targeted ad placements) with supply (publishers and networks offering ad space) by using real-time data and algorithms. These platforms automate the buying and selling process, allowing advertisers to bid on ad slots based on viewer profiles, behavior, and context, optimizing reach and engagement for specific audiences. Often marketing content is inefficiently published with limited relevance and to both customers and non-customers alike. However, they fail to prioritize fans, fan communities, and fandom metrics through an embargo hub fan ecosystem when determining content optimization, environmental impact, and commercial economics. In another aspect, the ecosystem can be used to valuate the media value of a fan community, or sponsorship, or associated marketing, or combinations or all of these, to a fan, fan community, adjacent fandoms or collaborative communities, or a combination or all of these, to help understand the dynamic value and environmental impact of the advertising space around specific content or branded content. This presents a novel way to assist with sponsorship valuation.

In another aspect, the cohort of fans could be determined in advance or be determined through the process of the embargo hub such that fans could be identified as “known” for purposes of marketing and invited to join the embargo hub. Alternatively, for purposes of comparison it may be important to specifically invite fans that are ambivalent to the product or service as a control group, or it might even be important to invite fans that are known to be opposed to the product or service to determine the effectiveness of that marketing.

In another aspect, the present invention provides methods of modelling both content generation, limited access and distribution to provide unique content to select fans, fandom, and fanness in new ways to help understand their correlation and improve upon marketing rapidly over time.

And lastly, in another aspect, the present invention helps provide a broad and novel understanding of fans, fandom, and fanness including what it means to be a fan in a community of fans, levels or classes of fans, transitions of fans in and out of fan communities and the reasons associated with those transitions, and what it is to not be a fan of a product, goods, services, or content or combination of the above or all of the above and why.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 depicts a block diagram of the system, methods, and device for providing customized marketing content to fans while optimizing the selection of the content and fans in a dynamic manner.

### REFERENCE NUMERALS IN DRAWINGS

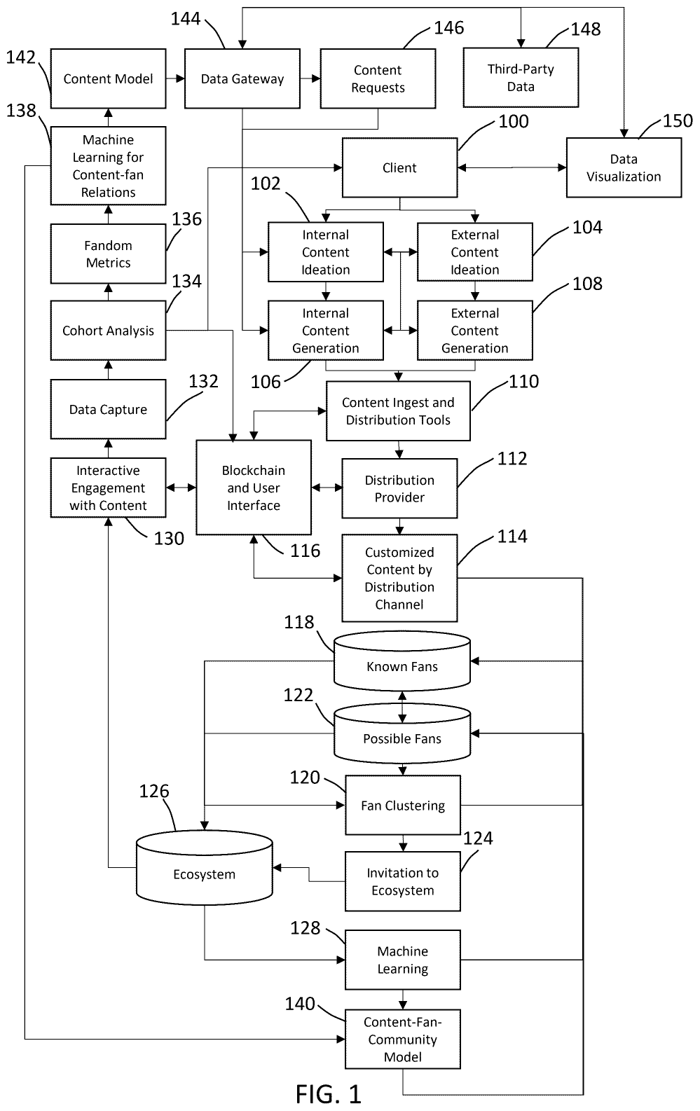

### Reference Numerals in FIG. 1:

100 Client
102 Internal content ideation
104 External content ideation
106 Internal content generation
108 External content generation
110 Content ingest and distribution tools
112 Distribution provider
114 Customized content by distribution channel
116 Blockchain and user interface
118 Known fans
120 Fan clustering
122 Possible fans
124 Invitation to ecosystem
126 Ecosystem
128 Machine learning
130 Interactive engagement with content
132 Data capture
134 Cohort analysis
136 Fandom metrics
138 Machine learning for content-fan relations
140 Content-fan-community model
142 Content model
144 Data gateway
146 Content requests
148 Third-party data
150 Data visualization

### DETAILED DESCRIPTION OF THE INVENTION

A preferred embodiment of the present invention is illustrated in FIG. 1.

A client 100 interested in marketing the right content in the right manner to the right fan or fan community, chooses to compose appropriate content through a process of either internal content ideation 102 through an internal department, such as marketing or external content ideation 104 through an external provider. A combination of either or both of these ideation processes can be used for internal content generation 106 or external content generation 108. Content ingest and distribution tools 110 are then used by a distribution provider 112 to provide customized content by distribution channel 114 in a way that maximizes the perceived relevance of the content to the fans receiving the content in each distribution channel. These distribution processes are recorded through a blockchain and user interface 116 that tracks the content as it is delivered to which distribution channel and to which person receiving the content in a manner that is secure and/or verifiable. In a preferred embodiment, the customized content specific to the distribution channel is provided to known fans 118, including those designated by the client or associated with particular fandoms, goods, services, or activities, as well as a range of fans based on their level of engagement and their fanness, which is deemed significant for observation in a controlled setting. While it is possible to determine the set of known fans through social network or other information, the system and method provided here helps to ensure that the pool of known fans is properly sized for each distribution channel and tracks dynamically with the available content, and as fans change their behavior and interest. For a given initial set of known fans, a process of fan clustering 120 using statistical analysis, machine learning, or other clustering approaches helps to subdivide fans by their similarities, interests, characteristics, likes, dislikes, previous behavior, or other data that can help to assess fandom. These clusters help to inform on the likelihood that someone from the much larger universe of all possible fans 122 may also be identified as a known fan of the client or content being distributed. The fans or fan cluster of greatest relevance to the evaluation of content being distributed in a particular distribution channel of interest are invited to enter a marketing ecosystem 124 as a cohort. Within the ecosystem 126, unique content is provided to this cohort in an environment, such as through a secured embargo hub, where the cohort of fans are not allowed to discuss the content publicly but may comment on the content privately within the ecosystem to the provider of the content being distributed or between other members of the ecosystem. A process of machine learning 128 is used to review all of the content and fan interaction within the ecosystem, to help inform about characteristics that are perceived to be of value when labeling possible fans as known fans. This machine learning can be static or dynamic, in real-time or not, to help invite fans to the ecosystem or provide valuable information about what it means to be a fan for the specific distribution channel at that time relative to the content being provided. Within the ecosystem, each cohort interacts with static or dynamic content 130 with the information associated with the ecosystem under the blockchain. Processes of data capture 132 are used along with a cohort analysis 134 to provide information about fan behavior, in terms of the like or dislike of the content being provided, and even in terms of the quality of the fans themselves within the cohort and their dedication to the client and content itself. Information from the cohort analysis can be provided back to the client to help inform their decision making about their product, activity, or service, and the content being generated, helping to complete a cycle of learning about the mapping of content and fan behavior. Such analysis results in new ways to generate novel fandom metrics 136. This analysis about the fans within the ecosystem can be used as input to machine learning for content-fan relations 138 to generate new models of the interaction of fans and content resulting in a different content-fan model 140 and a content model 142. A bi-directional data gateway 144 is used to integrate and transfer the ecosystem data to third parties 148, resulting in efficient fan and community metrics data extraction and data delivery to third parties, or the inclusion of third-party data in the machine learning and content model calculations. The content model can then be used to help generate new content requests 146 for internal content generation in real time which may improve fan interest and interaction in a dynamic manner. The data resulting from this system and method can be visualized 150 and provided to a client in an interactive manner to allow for improved understanding of the dynamics of fan behavior relative to marketing material as well as metrics such as the environmental impact of the marketing.

It is to be expected that the description of the preferred embodiment is not a limitation on variations or extensions of the invention. For example, there may be many ways to measure fan quality within an ecosystem, such as an embargo hub, and in fact the embargo hub itself can become a resource for the analysis of fan behavior and novel fandom metrics. The embargo hub can also be used to help launch and develop content, products, services, advertising or their combination, by communicating content in a manner that is targeted to a cohort of fans securely in a closed marketing ecosystem. This approach also has the benefit of building fan advocacy and fan community for a brand and/or product, giving a special opportunity to view content before other consumers or possible fans. In addition, aspects of the blockchain could include tokenization with or without reward for specific content behaviors.

While our preferred embodiment focuses on a broad view of fan-content interaction and fan-community interaction, those trained in the art of content delivery recognize that our approach could also be either fan-content interaction only or fan-community interaction only. However, our preferred embodiment utilizes both for improved marketing content and delivery over time.

This invention described here is useful for optimizing marketing content to recipients of that content based on the content, distribution channel and engagement and information about the fan through an interactivity. The invention combines information about brands, fans, the fan communities and information about content through a private, secured, ecosystem in the form of an embargo hub that is either digital, analog, or a combination of digital and analog. The system and method can be used to drive new content generation, and media valuation to the right fans at the right time in a dynamic manner and allow for the understanding and identification of new likely fans from the far larger pool of possible fans. While in the preferred embodiment such content is digital, the same approach could also be used to provide analog content or combination of digital and analog content to consumers. While the preferred embodiment addresses content to fans associated with marketing of digital content, such fans or fandoms are of broad scope including already established brands or fandoms such as fans of creative material such as brands such as Apple, Tesla, and Netflix, but also Walmart and Amazon, universities, sports teams, musicians and other entertainment, gaming communities, but also can include any large group of people who feel similar engagement with a brand as in politics or religion. For instance, in the pharmaceutical industry, such engagement could take the form of users who have choices for specific medicines where the embargo hub represents a way to optimize marketing content to such user communities, develop them as fans of the medicine or company producing such medicines, and then market content to help improve market share of a larger community of individuals who would benefit from use of the medicines. Data from the embargo hub helps inform the pharmaceutical company about remote users, their demographics, trends, or other medical issues, assisting with future clinical development or clinical trial design or identification of additional medical indications. Data from the embargo hub can also help inform the pharmaceutical company about which fans are most likely to no longer be fans and hop to a competitor medicine if marketed incorrectly. It will be appreciated that details of the foregoing embodiments, given for purposes of illustration, are not to be construed as limiting the scope of this invention. Although several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

1. A system for the improved understanding and use of fans, fandom, and fanness, the system comprising: a secured marketing ecosystem and data storage system for storing information about content, fans, and their behavior, wherein internally or externally derived content is distributed to fans of any chosen degree of fanness; where fans are clustered based on their fandom relative to the associated content and brand; wherein specific fans of a known fan community and/or fandom are invited to the ecosystem to engage with content; with data captured about the fan cohorts, content, and their interaction; for the purpose of improved modeling of content, content generation, content timing, fan community size, fan behavior, fan clustering, fandom, and fanness.

2. A method for the improved understanding and use of fans, fandom, and fanness, the method comprising: providing internal or external content through distribution tools, providers, and channels via a blockchain secured platform consisting of a marketing ecosystem wherein: content is provided interactively to fans of any chosen degree of fanness, wherein data is captured about the interaction of fans and content, wherein data analysis can be used to improve understandings of content, fans, and their combination; identifying and clustering fans and possible fans on a spectrum of fandom from least to most relative to brand and content; wherein the information from the embargo hub is used to improve understanding of a fan community, and/or fandom and fan clustering to identify new likely fans, invite fans to the ecosystem, and provide the right content to the right fan at the right time; wherein the improved understanding of fan and content interaction leads to improved content generation, improved understanding of fandom, and improved brand and marketing value, and where data driven fandom metrics are configured to analyze fan engagement with specific brands and/or products, enabling the quantification of the monetary value of marketing content relative to fan engagement, thereby facilitating informed content investment decisions and predicting content elements that are likely to yield the highest returns based on fan behavior and engagement levels.

3. The system of claim 1, wherein the marketing ecosystem can be analog or digital or a combination of analog and digital.

4. The system of claim 1, wherein content ideation by a client is either internal or external and informed by the results of the marketing ecosystem.

5. The system of claim 1, wherein distribution of content to fans is through modern internet standards, blockchain, and user experience services, and customized by distribution channel.

6. The system of claim 1, wherein the set of fans of the known fan community or fandom or combination of known fan community and fandom are used to initialize an embargo hub within the marketing ecosystem to engage with content and wherein approaches of fan clustering or other fan metrics are used to identify possible fans that can also be invited to the ecosystem as a cohort if so desired.

7. The system of claim 1, wherein processes of machine learning, artificial intelligence, statistical inference or their combination are used to learn about fans, their fan community, their interaction, their clustering, and behavior within the marketing ecosystem resulting in a content-fan community model that can be used to predict the success or failure of content to fans of different types over time and be used to identify possible new fans for specific content and be used to adjust new content ideation or generation in the form of a content model.

8. The system of claim 7, wherein the content model is used to help inform content ideation, content generation or both content ideation and generation in light of a request for content that could be used for marketing.

9. The system of claim 1, wherein the data captured about the fan cohorts, content, and their interaction are used for cohort analysis to understand and improve metrics about fans, their quality, their dynamics, and relation to content.

10. The system of claim 1, wherein data captured about the fan cohorts can be used directly by clients to improve their own understanding of fans and their fan communities, of their products or services.

11. The method of claim 2, wherein the spectrums of fandom or fanness can be quantified and understood over time relative to static or dynamic content provided through an embargo hub.

12. The method of claim 2, wherein the identifying and clustering of fans makes use of statistical analysis, machine learning, or combination of statistics and machine learning.

13. The method of claim 12, wherein machine learning includes a combination of neural networks, deep learning, generative models, language models, evolutionary algorithms, reinforcement learning, support vector machines, random forest methods, swarm optimization and fuzzy logic.

14. The method of claim 2, wherein fans may communicate and share insight together within the ecosystem in a secured manner.

15. The method of claim 2, wherein the improved understanding of fandom takes the form of quantitative measures, qualitative measures, or a combination of quantitative and qualitative measures.

16. The method of claim 2, wherein the fan user and marketing data from the ecosystem, and provided to the ecosystem, is provided via third-party systems and methods using a bi-directional data gateway to inform decision making.

17. The method of claim 2, wherein data from the marketing ecosystem is provided to generative pre-trained transformers for content generation to drive fan growth and community activation.

18. The method of claim 2, wherein fan users may be human, other biological entities, representations of humans or biological entities, or completely autonomous, intelligent, non-biological forms.

19. The method of claim 2, wherein fandom metrics are used as performance indicators including as a global standard of measurement of fans in order to compare fandoms across markets, companies, brands, or communities in an equivalent manner for the evaluation of relative brand performance or as a new consumer sentiment index.

20. The system of claim 1, wherein the data resulting from the embargo hub are used to dynamically calculate an environmental impact metric for marketing to a fan, fan community or fans and fan communities within each marketing channel.
